(19) United States
(12) Patent Application Publication
(10) Pub. No.: US 2011/0049860 A1
(43) Pub. Date: Mar. 3, 2011

(54) ASSEMBLY OF A BOOKSTAND AND A BOOK

(76) Inventor: Jung Ok SUH, Louisville, KY (US)

(21) Appl. No.: 12/550,242

(22) Filed: Aug. 28, 2009

(51) Int. Cl. B42D 3/00

(52) U.S. Cl. 281/33

(57) ABSTRACT

A bookstand-book assembly comprises a book having a hard cover, the hard cover defined by a base panel and first and second panels, wherein the first and second panels extend from the base panel to serve as front and rear book covers, wherein the base panel serves to cover and protect the binding of the book wherein the base panel has an opening, and a support releasably seated in the opening and engaged to a portion of the base panel adjacent to the opening so that when released from the opening the support serves as a book stand to secure a predetermined angle between the base panel and a flat area serving as a desk top.

### BACKGROUND OF THE INVENTION

This invention relates to a bookstand incorporated to a hardcover book, more particularly to an assembly of a bookstand and a book, facilitating an instant reading while minimizing fatigue to a reader's neck and shoulders.

It is often convenient for a reader to set a book down at an angle so that it may be easily read, thereby freeing the reader's hands. A bookstand may enable the elderly to be able to read a book without having to hold it, especially if the book is a particularly heavy hardcover volume such as a family bible. Several disadvantages are witnessed in conventional bookstands supporting a book at various desired angles. For example, existing bookstands typically have bulky or complicated mechanisms for holding a book at an angle.

A hardcover book like a bulky bible and other religious books may be convenient to make an instant reading if a bookstand is attached to a heavy book being read in a frequent manner.

### SUMMARY OF THE INVENTION

The present invention is contrived to overcome the conventional disadvantages. Accordingly, an objective of the present invention is to provide an assembly of a bookstand and a book, facilitating an instant reading while minimizing fatigue to a reader's neck and shoulders.

Another objective is to provide a book-bookstand assembly enabling an easy setting down of a bulky book an a desired angle.

A still another objective is to provide an assembly of a bible and a releasable bookstand incorporated in the bible.

To achieve these and other objectives, a collapsible book assembly comprises a book having a hard cover, where the hard cover is defined by a base panel and first and second panels. The first and second panels extend from the base panel to serve as front and rear book covers. The base panel serves to cover and protect the binding of the book. The base panel has an opening.

A support may be releasably seated in the opening and engaged to a portion of the base panel adjacent to the opening so that when released from the opening the support serves as a book stand to secure a predetermined angle between the base panel and a flat area serving as a desk top.

In an embodiment, an upper end of the support may be hingedly engaged to a portion of the base panel adjacent to the opening. The assembly may further comprises a zipper tying the first and second panels to enclose the book. Alternately, the assembly may further comprise a pair of wings releasably embedded in the support, where the wings are released from the support when the support is released.

For a better performance, the assembly may further comprise a pair of wings releasably embedded in the support, where the wings are elastically released from sides of the support when the support is released. A push to the support may lead to its release from the opening or to its pop release from the opening.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a book-bookstand assembly according to the present invention;

FIG. 2 is a schematic view showing the setting of the assembly according to the present invention;

FIG. 3 is an exploded view showing a mechanism of the assembly according to the present invention;

FIG. 4 is a schematic view showing an embodiment according to the present invention;

FIG. 5 is a schematic view showing another embodiment according to the present invention;

FIG. 6 is a perspective view showing a further embodiment according to the present invention; and

FIGS. 7 and 8 are schematic views showing variations of the book support according to the present invention.

### DETAILED DESCRIPTION OF THE INVENTION

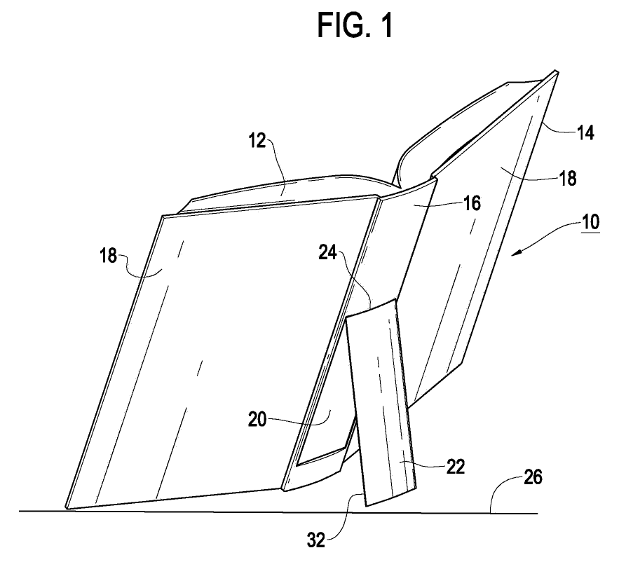

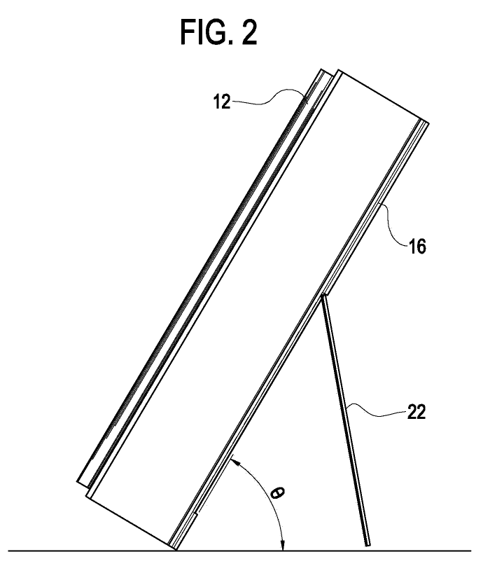

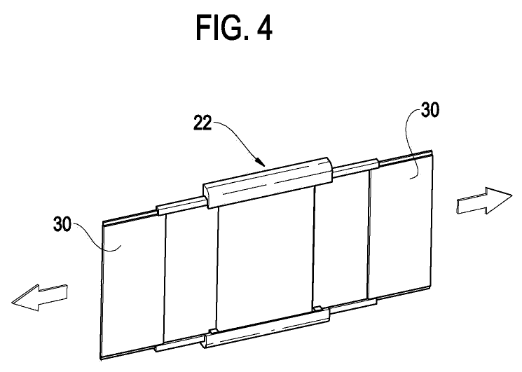

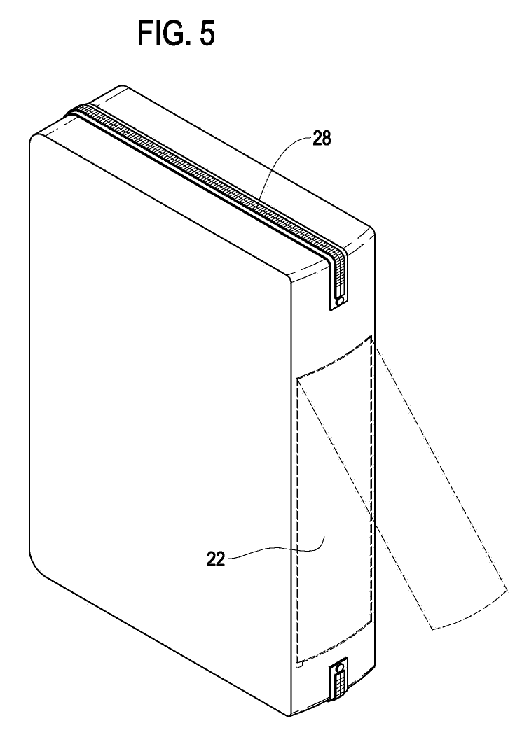

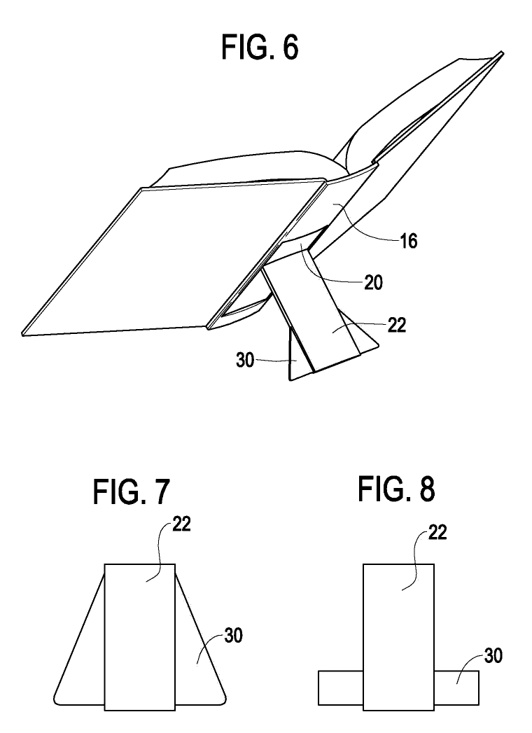

As shown in FIGS. 1 to 8, a bookstand-book assembly 10 according to the present invention comprises a book 12 having a hard cover 14. A bulky book with a substantial volume may be applicable to the book 10. The hard cover 14 covering the book is defined by a base panel 16 and first and second panels 18. The first and second panels 18 extend from the base panel 16 to serve as front and rear book covers. The base panel 16 serves to cover and protect the binding of the book 12. The base panel 16 has an opening 20.

In this construction, a support 22 is releasably seated in the opening 20 and engaged to a portion 24 of the base panel 16 adjacent to the opening 20 so that when released from the opening 20 the support 22 serves as a book stand to secure a predetermined angle θ between the base panel 16 and a flat area 26 serving as a desk top.

The bookstand-book assembly 10 may further comprise a zipper 28 tying the first and second panels 18 to enclose the book 12. A family bible is an example of a zipper book. Further comprised in the bookstand-book assembly 10 are a pair of wings 30 which are releasably embedded in the support 22, where the wings 30 are released from the support 22 when the support 22 is released. Preferably, the wings 30 may be released from sides 32 of the support 22 when the support 22 is released so as to further stabilize propping of the assembly 10.

In a preferred version, a spring mechanism may apply to the construction of the support 22 and the wings 30 so that the wings 30 can be elastically released from sides 32 of the support 22 when the support 22 is released.

In order to induce an easy release of the support 22 from the base panel 16, a push-open may apply so that a push to the support 22 leads to its release from the opening 20. Alternately, the support 22 may be engineered so a push to the support 22 leads to its pop release from the opening 20.

Depending upon the demand, the support 22 may be color matched with the base panel 16 for esthetic purposes. Examples of the book 12 may be one selected from a religious book like a family bible, a dictionary, and a medical reference book with a volume. Other types of bulky and heavy books may also apply to the bookstand-book assembly 10.

For a better performance, the support 22 may be automatically released from the opening 20 when a predetermined angle is made between the base panel 16 and the flat area 26 preferably with a bottom of the book abutting to the flat area 26. The support 22 is detachably engaged to the portion 24 of the base panel 16 to allow a user to selectively remove the support 22 when needed.

The opening 20 may be substantially formed in rectangle or in trapezoid depending on the user's preference.

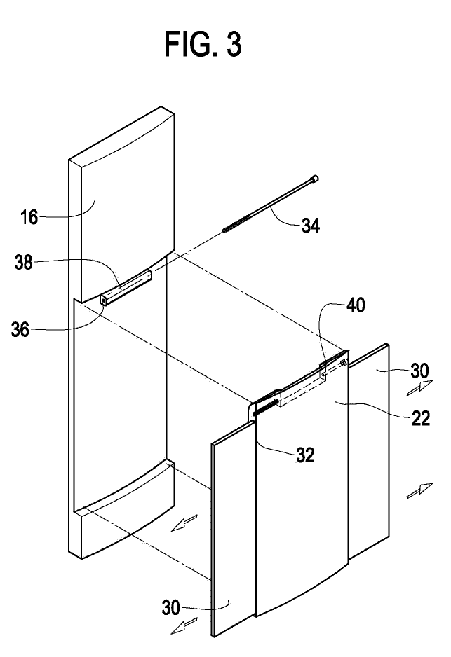

In an embodiment, the support 22 releasably seated in the opening can be formed such that an upper end 40 of the support 22 is hingedly engaged to the portion 24 of the base panel 16 adjacent to the opening 20. As further shown in FIG. 3, the hinge mechanism of the assembly 10 includes a pin 34, a pin hole 34 formed through a protrusion extending from the support 10 with a corresponding portion formed at an upper portion 40 of the support 22. The hinge mechanism may reduce cost while improving reliability.

With respect to the above description, it is to be realized that the optimum dimensional relationships for the parts of the bookstand-book assembly 10, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A bookstand-book assembly, comprising:
a book having a hard cover, the hard cover defined by a base panel and first and second panels, wherein the first and second panels extend from the base panel to serve as front and rear book covers, wherein the base panel serves to cover and protect the binding of the book, wherein the base panel has an opening; and
a support releasably seated in the opening and engaged to a portion of the base panel adjacent to the opening so that when released from the opening the support serves as a book stand to secure a predetermined angle between the base panel and a flat area serving as a desk top.

2. The bookstand-book assembly of claim 1, further comprising a zipper tying the first and second panels to enclose the book.

3. The bookstand-book assembly of claim 1, further comprising a pair of wings releasably embedded in the support, wherein the wings are released from the support when the support is released.

4. The bookstand-book assembly of claim 1, further comprising a pair of wings releasably embedded in the support, wherein the wings are released from sides of the support when the support is released.

5. The bookstand-book assembly of claim 1, further comprising a pair of wings releasably embedded in the support, wherein the wings are elastically released from sides of the support when the support is released.

6. The bookstand-book assembly of claim 1, wherein a push to the support leads to its release from the opening.

7. The bookstand-book assembly of claim 1, wherein a push to the support leads to its pop release from the opening.

8. The bookstand-book assembly of claim 1, wherein the support is color matched with the base panel.

9. The bookstand-book assembly of claim 1, wherein the book is a religious book.

10. The bookstand-book assembly of claim 1, wherein the support is automatically released from the opening when a predetermined angle is made between the base panel and the flat area.

11. The bookstand-book assembly of claim 1, wherein the support is automatically released from the opening when a predetermined angle is made between the base panel and the flat area with a bottom of the book abutting to the flat area.

12. The bookstand-book assembly of claim 1, wherein the support is detachably engaged to the portion of the base panel

13. The bookstand-book assembly of claim 1, wherein the opening is substantially formed in rectangle.

14. A bookstand-book assembly, comprising:
a book having a hard cover, the hard cover defined by a base panel and first and second panels, wherein the first and second panels extend from the base panel to serve as front and rear book covers, wherein the base panel serves to cover and protect the binding of the book, wherein the base panel has an opening; and
a support releasably seated in the opening, wherein an upper end of the support is hingedly engaged to a portion of the base panel adjacent to the opening so that when released from the opening the support serves as a book stand to secure a predetermined angle between the base panel and a flat area serving as a desk top.

15. The bookstand-book assembly of claim 14, further comprising a zipper tying the first and second panels to enclose the book.

16. The bookstand-book assembly of claim 14, further comprising a pair of wings releasably embedded in the support, wherein the wings are released from the support when the support is released.

17. The bookstand-book assembly of claim 14, further comprising a pair of wings releasably embedded in the support, wherein the wings are released from sides of the support when the support is released.

18. The bookstand-book assembly of claim 14, wherein the support is color matched with the base panel.

19. The bookstand-book assembly of claim 14, wherein the book is a religious book.

20. The bookstand-book assembly of claim 14, wherein the opening is substantially formed in rectangle.
